(19) United States
(12) Patent Application Publication
(10) Pub. No.: US 2009/0084601 A1
(43) Pub. Date: Apr. 2, 2009

(54) Weatherproof chamber for a receptacle with GFI capability

(76) Inventors: Mike Masinter, Campbell, CA (US); Brian Greene, Morgan Hill, CA (US)

Correspondence Address: SCHNECK & SCHNECK, P.O. BOX 2-E, SAN JOSE, CA, 95109-0005, US

(21) Appl. No.: 12/229,569

(22) Filed: Aug. 25, 2008

Related U.S. Application Data
(60) Provisional application No. 60/966,108, filed on Aug. 24, 2007.

(51) Int. Cl. H01R 13/52

(52) U.S. Cl. 174/520

(57) ABSTRACT

An electrical receptacle includes an outlet that is protected from the environment in which the receptacle is used. The receptacle is designed for below grade use, such as in a tree well for providing tree lighting or other application in which a dry, clean environment is required. The plug end of a detachable power cord is inserted into the outlet of the receptacle, with foam or similar material being used to maintain the weatherproof condition as the cord exits from the receptacle. The receptacle is prewired for connection to a source of power via a raceway, but Ground Fault Interrupter (GFI) protection breaks the connection from the power source to the cord that is inserted into the outlet, if an unsafe condition is detected.

### CROSS REFERENCE TO RELATED APPLICATION

This application claims priority from co-pending provisional application No. 60/966,108, filed Aug. 24, 2007.

### TECHNICAL FIELD

The invention relates generally to providing electrical power and more particularly to an electrical receptacle that is installed below grade or in wet locations that require an enclosure which provides a safeguard against moisture.

### BACKGROUND ART

There are a number of different situations in which an electrical component is used “below grade” (i.e., below ground level). As one example, the component may be a receptacle housing for an electrical outlet that is used in providing power for outdoor use, such as tree lighting or other application in which a protected receptacle housing is required. Importantly, below-grade electrical components are exposed to dust, dirt and moisture, so protection from the environment is a concern.

Protective housings for environmentally exposed electrical receptacles are known. U.S. Pat. No. 5,621,192 to Bordwell et al. describes a protective housing that includes a box and a cover surrounding one or more outlets. A gasketless joint is formed between the hinged cover and the box for inhibiting entry of moisture. A slot within a peripheral wall is designed to receive a cord that extends to a plug within the box. The Bordwell et al. housing is not described as being intended for use below grade. A related device is described in U.S. Pat. No. 4,109,095 to Kling et al. This patent describes a weatherproof box cover that has a pair of lids which are biased toward each other, so as to provide self-closing. The lids have gear-like portions which mesh together so as to synchronize movement of the lids. In addition, each lid has a recess along its outer edge in which a resilient sealing strip is seated. When closed onto an electrical cord, the sealing strips conform to the shape of the cord and the strips remain in a seal-tight relationship. Thus, stray water and the like are prevented from entering the area in which the cord is connected to the plug.

While the prior art operates well for its intended purpose, further advances are desired, particularly where an electrical connection is to remain below grade.

### SUMMARY OF THE INVENTION

An electrical receptacle in accordance with the invention utilizes both “passive” protection against adverse conditions and “active” protection against occurrences of faulty conditions. The electrical receptacle provides an outlet for a detachable power cord, with the passive and active protections allowing the receptacle to be well suited for use in below-grade installations.

The active protection is achieved by integrating a protection circuit having fault sensing into a housing for the electrical receptacle. In the preferred embodiment, the protection circuit provides Ground Fault Interrupter (GFI) protection, thereby achieving a safeguard for individuals. As is known in the art, GFI protection senses stray currents that are indicative of unintended electrical flow, such as current through a human body. The protection circuit preferably includes a reset that returns the receptacle to full operation after correction of the fault condition.

The passive protection is achieved by a cooperation of housing components to safeguard electrical components. In the preferred embodiment, the housing includes an outlet section and a chamber section. The protection circuit is integrated into the outlet section such that its circuitry is sealed. An electrical outlet of the type that mates with a conventional detachable power cord is also fixed within the outlet section, but the socket face of this outlet is exposed to the interior of the chamber section. The outlet section is “prewired.” That is, wiring which is intended for subsequent coupling to the original source of electrical power is connected to both the protection circuit and the electrical outlet prior to installation of the receptacle for access by the detachable power cord.

The chamber section includes a chamber which is sufficiently large to house the plug end of the detachable power cord after the plug end has been coupled to the outlet. An access door can then be closed and latched, but conformal material ensures a sealing engagement with the cord. Foam or another material which is resilient and compressible is used, so that the dimensions of the cord are not significant. Rubber gaskets may be included at the opposite ends of the conformal material.

Those portions of the housing which are exposed to weather conditions should be formed of material that is primarily plastic or other weatherproof electrically insulative material. A suitable material is non-conductive polyvinyl chloride (PVC). In one preferred embodiment, the housing is cylindrical, with the opening that receives the prewiring at one end of the cylinder and the exit for the detachable power cord at the other end. The receptacle may be free moving following installation or may be mounted in a particular position. The receptacle may include a mounting structure that allows connection to a ground-mounting spike or a wall-mounting bracket. During use, the horizontal or vertical orientation is not significant.

### BRIEF DESCRIPTION OF THE DRAWINGS

FIG. 1 is a perspective view of the receptacle in accordance with one embodiment of the invention.

FIG. 2 is a representation of the receptacle of FIG. 1 in one possible application.

FIG. 3 is a side view of the receptacle of FIG. 1 with alternative mounting devices.

FIG. 4 is an end view of the receptacle of FIG. 1.

FIG. 5 is a view from the opposite end of the receptacle of FIG. 4.

### DETAILED DESCRIPTION

With reference to FIG. 1, a receptacle 10 is shown as being in an open condition, so that the plug end 16 of a conventional detachable power cord 12 is exposed. When in use, the plug end is seated into an electrical outlet 14. In the embodiment shown in FIG. 1, the plug end is of the three-prong type. The socket face of the electrical outlet has a corresponding configuration, as is well known in the art. With a door 18 in the open position shown in FIG. 1, the plug can be inserted into the outlet. Following insertion, the hinged door is closed and locked in position by a pair of latch members 20 and 24. When the door is closed, a weatherproof receptacle chamber 23 is formed to protect the electrical components.

In the particular configuration shown in FIG. 1, the receptacle 10 is cylindrical in shape. One advantage of this configuration is that the cylindrical receptacle is well suited for below-grade installations. The wiring 30 to the original source of power (such as a junction box) extends from one axial end of the receptacle, while the detachable power cord 12 extends from the opposite end. The cylindrical receptacle readily fits into areas in which space is an issue. The length of the receptacle may be approximately ten inches (254 millimeters). The diameter may be three inches (76.2 millimeters). In the illustrated embodiment, the length of the door may be seven inches (177.8 millimeters). However, other configurations that enable easy storage and use in small areas may be utilized.

The material for forming the receptacle 10 must be of the type that does not deteriorate from short-term exposure to normal weather conditions. Additionally, the receptacle should be impervious to dust. The receptacle is intended for use below grade, such as in a tree well, pullbox, or other area in which a weatherproof environment is required for an electrical connection of a power cord 12.

A pair of foam halves 24 and 26 achieve the purpose of allowing cords 12 of different external shapes and dimensions to be used with the receptacle in maintaining a weatherproof condition. The foam halves are compressible and have shape memory, so that the material will conform about the exterior of the cord 12.

The receptacle 10 includes GFI protection 28. This capability functions to interrupt the circuit upon detection of a current that is indicative of unintended (unsafe) flow. The GFI protection provides a circuit breaker between the outlet 14 and a source of power that is connected to the receptacle 10 by wiring 30 that is prewired to the GFI protection. This wiring 30 may be implemented by the conventional three-wire arrangement that corresponds to the wiring of the three-prong plug 16 of the cord 12. Under normal conditions, the GFI protection allows a closed circuit from the three wires to the corresponding prongs of the plug 16. However, when an unsafe condition is detected, the GFI protection opens the circuit. Preferably, the GFI includes a reset.

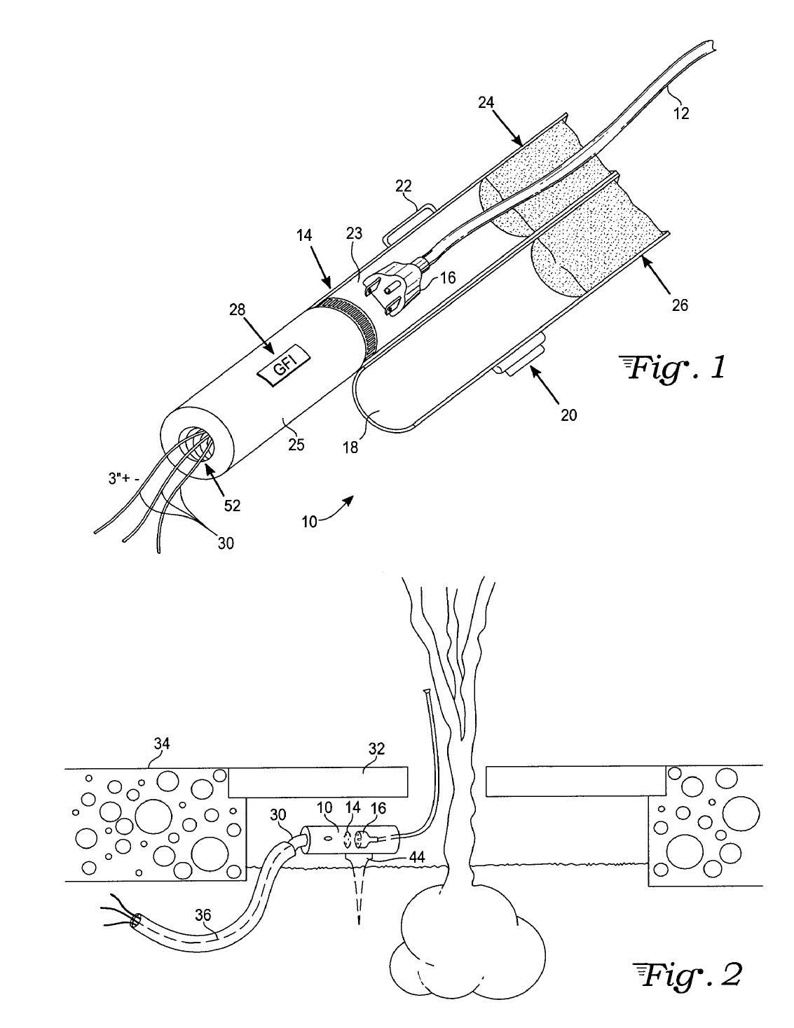

With reference to FIG. 2, the receptacle 10 is shown as being located beneath a tree grate 32 which is at ground level 34. When in use, the receptacle may be connected to a plug 16 of a power cord which extends from tree lights, such as Christmas lights (not shown). At the opposite end of the receptacle, the wiring 30 extends to a junction box or other means for providing power to the receptacle.

Referring to both FIGS. 1 and 2, one advantage of the invention is that the weatherproof receptacle is self contained, other than with respect to the cord 12 that provides access to the power capabilities of the receptacle 10. The receptacle is “self contained,” since the wiring 30 is pre-attached and the GFI protection 28 is integral to the receptacle. As shown, the wiring 30 may be protected by a raceway 36 (or other conduit) which is provided by a user to extend from a source of power to the area in which the receptacle is to reside. Another advantage of the invention is that the receptacle is formed such that its orientation is unimportant. That is, the receptacle operates equally whether in a horizontal position, a vertical position, or in a position between vertical and horizontal.

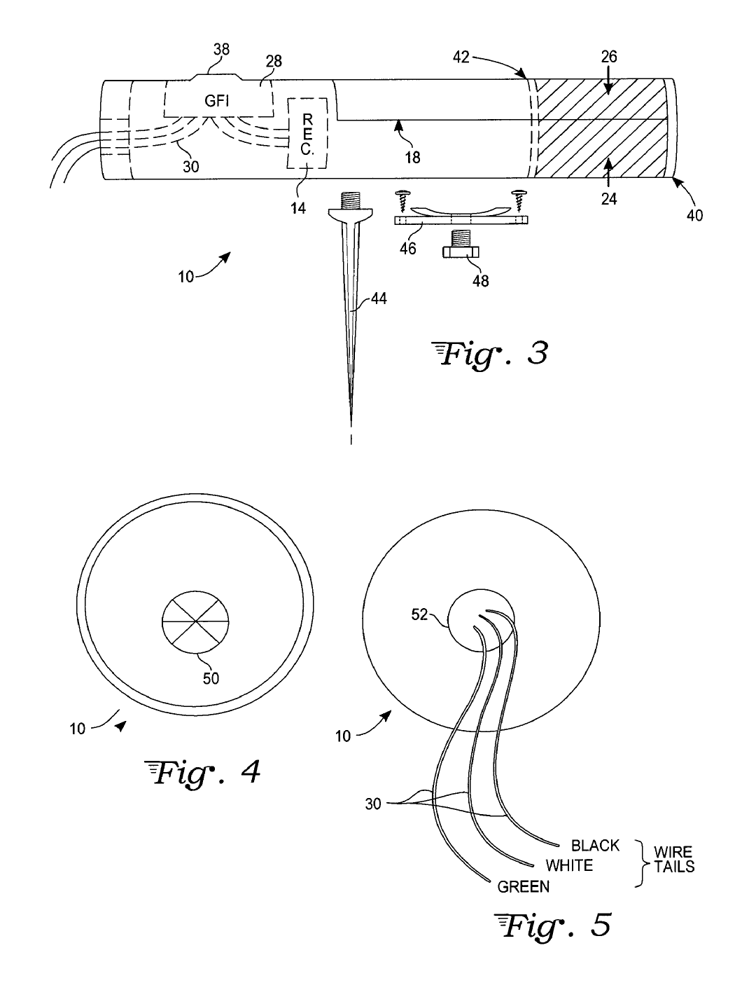

Referring now to FIG. 3, the connections of the GFI protection 28 are represented by dashed lines. The wiring 30 enters the interior of the receptacle 10 via a rigid or flexible conduit and connects to the GFI protection. The GFI protection is also connected to the outlet 14. Preferably, the GFI protection includes a reset button 38 that allows the receptacle 10 to be returned to its normal operation condition by a user, if the protection has been triggered.

At the end of the receptacle 10 opposite to the entrance of the wiring 30 are the foam halves 24 and 26. While not critical, the receptacle preferably includes a pair of rubber gaskets 40 and 42 positioned at opposite sides of the foam in order to ensure a proper seal.

The receptacle 10 may be used in a condition in which it is free of mounting hardware. Alternatively, one of the two mounting approaches shown in FIGS. 2 and 3 may be used. As one possibility, a ground mounting spike 44, such as shown in FIG. 2, may be threaded into the chamber and then pushed into the ground at a desired position. Alternatively, a wall . mounting bracket 46, such as shown in FIG. 3, may be used, with a bolt 48 passing through the bracket into a threaded hole of the receptacle. Hardware secures the bracket to the wall.

FIG. 4 is an end view of the receptacle 10, showing an opening 50 through which an electrical cord can be inserted during use. FIG. 5 shows the opposite side of the receptacle 10. The wiring 30 extends through a central threaded hub 52. When the wiring 30 is protected within a user-furnished raceway or other conduit, the raceway is threaded into the hub to provide a seal that prevents entrance of dirt or moisture.

In use, the electrical receptacle 10 of FIGS. 1-5 is initially prewired to include the wiring 30 to the GFI protection 28 and the electrical outlet 14. The electrical outlet and GFI protection are housed within an outlet section 25 of the receptacle, but the socket face of the outlet is exposed to the interior of the chamber 23. Optionally, the wiring 30 is protected by a conduit such as a raceway, but the conduit is typically added by the end user. The receptacle is then ready for installation in a wide variety of applications.

During installation, the electrical receptacle 10 is well suited for below-grade applications, such as shown in FIG. 2. A mounting spike 44 may be threaded into the receptacle and driven into the ground in order to provide clearance from moisture. As an alternative, the wall mounting 46 and 48 of FIG. 3 may be used. While not shown in FIG. 2, the conduit 36 is preferably threaded into the end of the receptacle 10. The wires may merely be short in length, but subsequently connected to lengthy wires extending from a junction box or other source of alternating current. The installation also includes connecting the plug 16 of the detachable power cord 12 into the outlet 14, so that the power can be used for the intended purpose, such as powering tree lights. To protect the connection, the door 18 is closed, causing the conformal foam halves 24 and 26 to deform around the cord portion of the power cord.

What is claimed is:

1. An electrical receptacle comprising:
a plurality of wires for conducting an alternating current from a source of electrical power;
a housing having an outlet section and a chamber section, said outlet section having an opening through which said wires extend;
a protection circuit integrated into said outlet section of said housing, said protection circuit being enabled for fault sensing;
an electrical outlet fixed within said outlet section while having a socket face exposed to said chamber section, said socket face being configured to receive a plug end of a detachable power cord, said plurality of wires being connected to said protection circuit and said electrical outlet;
a door cooperative with said chamber section to form a chamber dimensioned to house said plug end of said detachable power cord when said door is in a closed condition, said chamber having an exit for a cord portion of said detachable power cord; and
conformal material located relative to said door and said chamber section of said housing to conform about said cord portion at said exit when said door is in said closed condition.

2. The electrical receptacle of claim 1 wherein said protection circuit is a Ground Fault Interrupter (GFI) circuit that is exposed along an exterior surface of said outlet section.

3. The electrical receptacle of claim 1 wherein said housing is formed of an electrically insulative material selected for use in below-grade installations.

4. The electrical receptacle of claim 3 wherein said housing is formed of polyvinyl chloride (PVC).

5. The electrical receptacle of claim 1 wherein said conformal material is foam.

6. The electrical receptacle of claim 1 wherein said opening of said outlet section is internally threaded to receive a threaded conduit in which said plurality of wires extend.

7. The electrical receptacle of claim 1 further comprising a latch for securing said door to said housing when said door is in said closed condition.

8. The electrical receptacle of claim 7 wherein said door is hinged to said housing along one side of said door.

9. The electrical receptacle of claim 8 wherein said door, said housing and said conformal material are cooperative to weatherproof said chamber when said door is in said closed condition.

10. The electrical receptacle of claim 1 wherein said housing is cylindrical, said opening and said exit being at opposite ends of said housing.

11. An electrical receptacle for use in below-grade installations to provide an electrical outlet for a detachable power cord comprising:
an electrically insulative housing having an interior chamber;
an electrical socket located within said housing, said electrical socket having a socket face configured to include connections for receiving prongs at a plug end of said detachable power cord, said socket face being exposed to said interior chamber;
a Ground Fault Interrupter (GFI) at a surface of said housing;
prewiring extending into said housing and being electrically connected to said GFI and said electrical socket; and
an access door connected to said housing to provide access to said interior chamber, said access door having a closed condition relative to said interior chamber such that said interior chamber has a volume sufficient to contain said plug end of said detachable power cord and such that a weatherproof seal is achieved.

12. The electrical receptacle of claim 11 further comprising first and second sections of a conformable material which conforms to maintain said weather-proof seal when said access door is in said closed condition, said first section being on said access door, said second section being fixed within said interior chamber in alignment with said first section at a cord-exit area of said interior chamber.

13. The electrical receptacle of claim 12 wherein said conformal material is foam.

14. The electrical receptacle of claim 11 wherein said prewiring enters said housing through a threaded opening.

15. The electrical receptacle of claim 11 wherein said housing and said door define a cylindrical structure in which said prewiring enters at a first axial end and said cord-exit area is at a second axial end.

16. The electrical receptacle of claim 11 wherein said access door has a hinged connection to said housing along one edge and a latching connection to said housing at a second edge.

17. The electrical receptacle of claim 11 wherein said prewiring is three wires, said three wires being connected to said electrical socket in a manner compatible with providing alternating current to said detachable power cord.
